(19) United States
(12) Patent Application Publication
(10) Pub. No.: US 2008/0256116 A1
(43) Pub. Date: Oct. 16, 2008

(54) Publicly auditable polling method and system

(75) Inventors: Ronen Barzel, San Francisco, CA (US); Graham Walters, San Francisco, CA (US)

Correspondence Address: DLA PIPER US LLP, 153 TOWNSEND STREET, SUITE 800, SAN FRANCISCO, CA, 94107-1957, US

(73) Assignee: Modern PolityLLC, San Francisco, CA (US)

(21) Appl. No.: 11/786,612

(22) Filed: Apr. 12, 2007

(51) Int. Cl. G06F 17/30

(52) U.S. Cl. 707/102; 707/E17.005

(57) ABSTRACT

A method includes collecting poll data, generating a poll database which includes the poll data, and publishing the poll database, such that the poll data is accessible to at least one interested party. A system is also provided, which includes a server connected to a computer network and a data management application which provide a set of functions. The functions include obtaining poll data, creating a poll database which includes the poll data, and publishing the poll database, such that the poll data is accessible to at least one interested party.

### TECHNICAL FIELD

The present invention is directed generally to auditing a poll, and more specifically to a method and system for conducting a poll transparently by providing open access to poll data, e.g., for auditing purposes.

### BACKGROUND OF THE TECHNOLOGY

Existing election methods use a variety of technologies for voters to cast ballots, which have been the subject of much investigation, invention, and analysis in recent years. However, casting ballots is only the start: the final outcome depends on properly counting the ballots. As has been (dubiously) attributed to Josef Stalin: “Those who cast the votes decide nothing; those who count the votes decide everything.”

No existing election method provides participants or other interested parties with assurance that the counting process is correct. Interested parties must place their trust in agents or mechanisms to ensure the validity of the process and outcome; that all votes were properly interpreted and included; and that no spurious votes were counted. Even if the election method allows examination by independent auditors, participants must place their trust in the auditors and must trust that the auditors have access to sufficient data to yield a dependable audit. No current method allows poll participants or third parties to have access to sufficient poll data to audit, analyze, or otherwise increase trust in the validity of a poll process and outcome.

Additionally, no matter what method or technology is used to cast ballots and gather poll data, the process is always subject to accidental or intentional errors, wherein such errors can be due to faulty hardware, faulty software, or faulty human procedures. No existing election method accommodates or tracks how much of such error is introduced, nor admits the possibility that for close contests the introduced error may be larger than the margin of victory, thus making the true result indeterminate.

Accordingly, there is currently a need for a method and system of recording, gathering, and tallying votes in elections, polls, referenda, and other group decision-making processes in a manner that allows any interested party to analyze and audit the process to ensure that the results are arrived at correctly without needing to place trust in any specific agents or mechanisms. There is also a need for a method and system that accounts for errors in generating, gathering, processing, and interpreting the poll data, by supporting tests for data validity, by denoting the certainty or reliability of the poll data, and by reporting results with margins of error. And finally, there is currently a need for a method and system for improving the quality of the poll data, wherein errors and/or uncertainties in the poll data gathering and interpretation processes are detected and corrected in an auditable and defensible manner, so that the poll data more closely represents the intentions of the participants.

### SUMMARY OF THE INVENTION

The present invention solves the aforementioned problems by providing an improved method and system for auditing a poll.

In an embodiment of the present invention, a method for auditing a poll includes collecting poll data. The method further includes generating a poll database, which includes the poll data. Finally, the method includes publishing the poll database, such that the poll data is accessible to at least one interested party.

In another embodiment of the present invention, a system for auditing a poll includes a server connected to a computer network and a data management application executing in association with the server to provide a set of functions. The functions of this system include obtaining poll data. The system further includes the function of creating a poll database, which includes the poll data. Finally, the system includes the function of publishing the poll database, such that the poll data is accessible to at least one interested party.

As will be appreciated upon consideration of the following detailed description of the invention and accompanying drawings, there are many advantages and features of the present invention, which in turn lead to many new and useful applications of the invention.

### BRIEF DESCRIPTION OF THE DRAWINGS

FIG. 1 is a block diagram of an auditable polling system according to an embodiment of the present invention.

FIG. 2 is a flowchart describing an embodiment of a publicly auditable polling process according to the present invention that uses scanned paper ballot forms.

FIG. 3 is a flowchart describing an embodiment of a publicly auditable polling process according to the present invention that uses direct-recording (DRE) voting machines.

FIG. 4 is a flowchart describing an embodiment of a publicly auditable polling process according to the present invention that uses an electronic communications network.

FIG. 5 is an exemplary illustration of a scanned ballot form and electronic report according to the present invention.

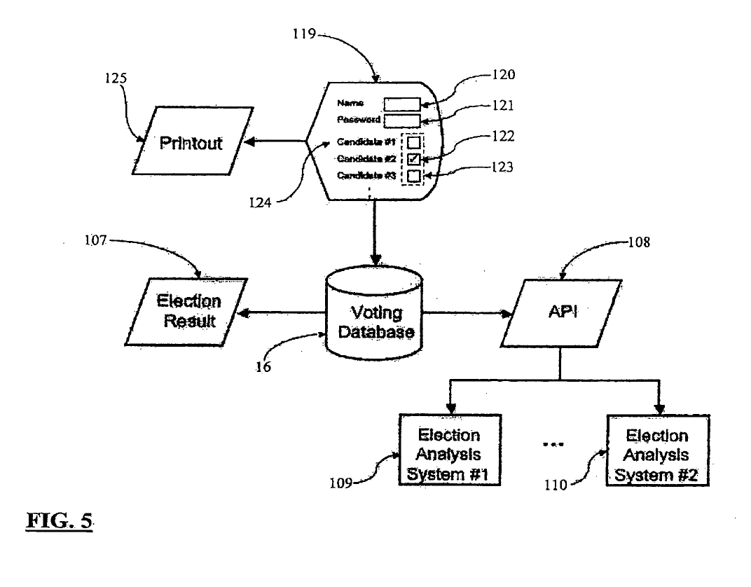

### DETAILED DESCRIPTION OF THE INVENTION

Unless otherwise indicated, all terms used herein have the same meaning as they would to one skilled in the art. The following terms are used frequently to define the invention, denote key concepts and are intended to be defined as indicated below.

Poll: An election, referendum, opinion poll, or any other group decision-making or opinion-sampling process.

Input Data: Any type of data provided by a poll participant, including preference data and ancillary data.

Ballot Form: The medium by which a poll participant enters his/her input data. Examples include tangible (e.g., paper) and electronic ballots. Electronic ballots may incorporate various technologies, such as display technology or audio (e.g. voice) input-output technology.

Ballot Identifier: A distinguishing feature by which a particular ballot may be identified. Examples include physical/electronic seals, serial numbers, distinguishing marks, alphanumeric strings, and the like.

Interested Party: Any individual having a particular interest in a poll.

Preference Data: The preferences expressed by the poll participants in response to items on the ballot. The preference data may be explicit in the input data or may be acquired by interpreting the input data. Typically, preference data refers to a poll participant's selection from a list of candidate choices expressed as votes on ballot items. Other types of preference data can include write-in choices, in which a participant provides a response other than one of the listed choices, or free-response data, such as when a voter participant provides answers to a series of questions, wherein no pre-selected answer choices are provided.

Ancillary Data: A form of input data. Typically, ancillary data refers to data that is gathered from participants in addition to the primary preference or opinion data. Examples include demographic data, annotations, and commentary.

Vote Gathering: The gathering of input data from poll participants.

Vote Interpretation: The interpretation of input data to ascertain the intended preferences of the poll participants, i.e., to yield preference data.

Vote Tallying: A process for counting preference data to determine an outcome or result of a poll.

Justificative Data: Information that explains, supports, defends, tracks or otherwise justifies the gathering, interpreting, and tallying of input data and preference data. Justificative data can also include records of decisions made and procedures followed.

Electronic Report: An electronic report is a report of derived data, input data, preference data, or justificative data.

Participation Data: A form of justificative data comprising a log of the number and/or identity of poll participants.

Provenance Data: A form of justificative data comprising a chain-of-custody log for documents and data involved in the polling process.

Derived Data: Data that is derived from some sort of computation or analysis on other data. Examples include the tallies of votes and summaries of preference data.

Poll Data: Any data associated with a poll including input data, preference data, justificative data, and derived data.

Poll Database: A list, collection, or relational database storing the poll data.

Ambiguous Data: A form of input data, wherein the intended preference of the voter is unclear. Examples include data that is invalid (e.g., where two candidate choices are selected when only one selection is allowed) and data that is uncertain (e.g., where it is unclear as to whether a paper ballot oval is sufficiently filled).

Public Audit Method: The method described herein for inspecting poll data. The public audit method applies to any sort of election, opinion poll, or other process in which objective data is gathered from a collection of participants, and for which there is interest among the participants or a wider public for being able to audit the data and results. For convenience in this document, we will use the common terms “election”, “ballot”, “ballot box”, “vote”, and “voter” with the understanding that the public audit method applies generally to opinion polls and other processes that involve gathering preference or opinion data from participants.

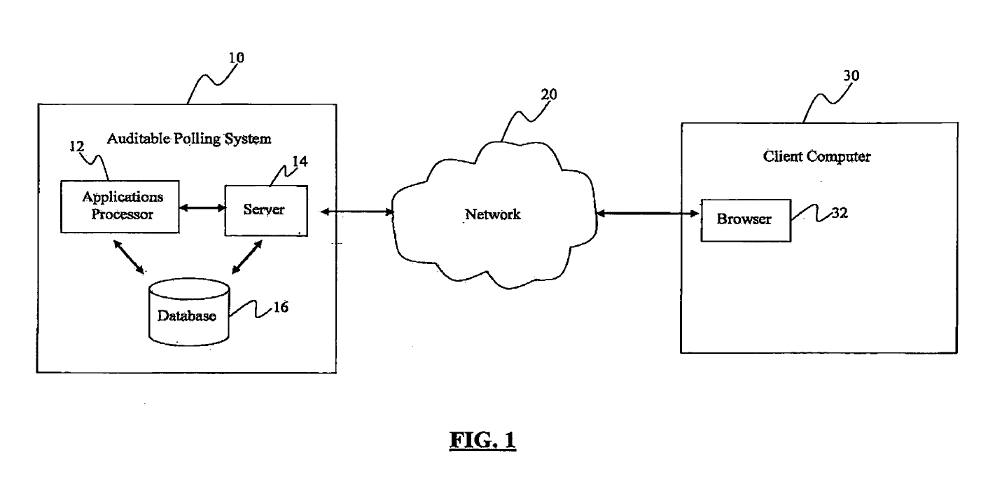

In one preferred embodiment, the audit method of the present invention is conducted over a wide area network. Referring first to FIG. 1, a block diagram is illustrated of a wide area network employing a method and system according to an embodiment of the invention. Although the invention is especially suitable for implementation on a system as will be described, the method may also be effectively implemented on other systems. It is anticipated that the present invention operates with a plurality of computers that are coupled together on a wide area network, such as the Internet 20, or other communications network. FIG. 1 depicts such a network that includes an auditable polling computer system 10 and a client computer 30. As illustrated, the auditable polling computer system 10 is further comprised of an applications processor 12 coupled to a server 14 and a poll database 16.

Within this embodiment, poll data is stored in poll database 16. Included in such poll data is input data, preference data, and derived data, as well as justificative data, which provides justifications for the recording, gathering, interpreting, and tallying of input data. The present invention provides a method and system for accessing poll data stored in poll database 16 so that interested parties can independently validate the results of a particular poll.

It should be further appreciated that server 14 may access a plurality of Web pages, distributable applications, and other electronic files containing poll data of various types stored in poll database 16. As a result, Web pages may be viewed on various web-enabled computers in a given network, such as a client computer 30. For example, a particular Web page or other electronic file may be viewed through a suitable application program residing on the client computer 30 such as a browser 32, or by a distributable application provided to the client computer 30, by server 14. It should be further appreciated that many different information retrieval devices, many different Web servers, and many different search servers of various types may be communicating with each other at the same time. Electronic files containing poll data of various types stored in poll database 16 may be output to any type of computer readable medium.

In an exemplary application, a client identifies a Web page it wishes to retrieve by communicating an HTTP (Hyper-Text Transport Protocol) request from the browser application 32. The HTTP request includes the Uniform Resource Locator (URL) of the desired Web page, which may correspond to an HTML document stored in poll database 16. The HTTP request is then routed to the server 14 via a network, e.g., the Internet 20. The server 14 then retrieves the HTML document identified by the URL, and communicates the HTML document across the Internet 20 to the browser application 32. The HTML document may be communicated in the form of plural message packets as defined by standard protocols, such as the Transport Control Protocol/Internet Protocol (TCP/IP).

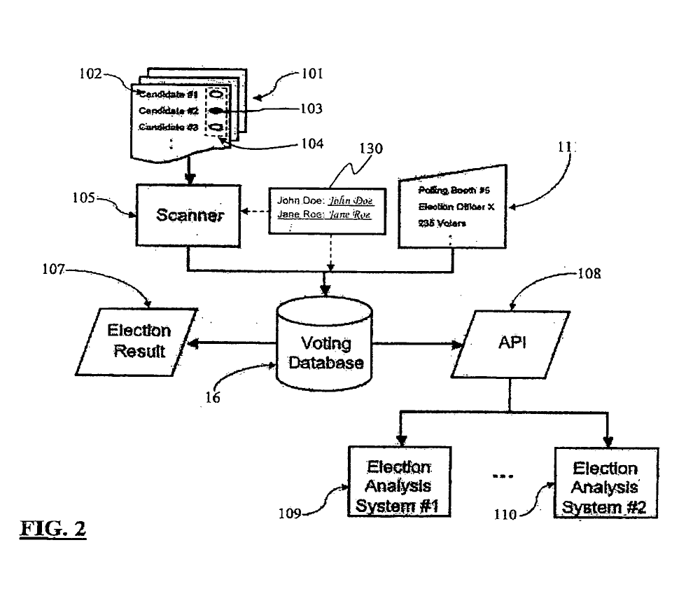

In FIG. 2, a flowchart of an audit method that uses scanned paper ballot forms according to an embodiment of the present invention is provided. Within this embodiment, voters participating in a poll express their preferences on a ballot by marking a paper ballot form 101. In particular, the poll participant inputs his/her preference data by darkening an oval box 103, 104, wherein each oval box corresponds to a particular candidate, opinion, or decision 102.

Within this embodiment, digital images of the filled-out ballot forms 101 are created using an optical scanner 105. Votes are then interpreted by recognizing the marks on the digital copies of the voting forms 101 using image-processing software. For each vote cast, a database record is then created and stored in poll database 16, which includes all the poll data for that particular vote., including the ballot form images and interpreted preference data.

For some embodiments, it should be appreciated that the degree to which oval box 103 has been darkened may be used to interpret a particular vote. Such degree can be computed, for example, by counting light and dark pixels within the boundary of the oval box 103, 104 in the scanned image of the ballot form 101. For such embodiments, justificative data may thus include the image of the paper form 101, as well as the ratio of dark to light pixels within each oval box 103, 104 on the form 101.

Another form of justificative data that may be included is the provenance data 111 associated with a set of ballots. Provenance data 111 may, for example, include a chain-of-custody log for all the ballots cast at a particular site. At each step, as ballot forms are transported from ballot boxes to scanners, and as digital data is transported or transmitted via local-area and wide-area communication networks to poll database 16, the chain-of-custody data may be logged. Provenance data 111 may also include: identity of polling place; names of agents, including poll officials; opening and closing times of polling places; numbers and statuses of voting booths and scanners; ballot count; voter count; lengths of waiting lines; times of ballot and data transfers; authorizations to proceed; and certifications that proper procedures were followed. Such provenance data 111 can then be incorporated either directly, or indirectly by generating optical image scans of paper documents via scanner 105, into the poll database 16.

Another form of justificative data that may be included is participation data 130. Participation data 130 may, for example, include a record of how many voters participated in a poll, which voters participated, and which polling place in particular was used to cast their votes. It should also be appreciated that, for some polling places, each voter must first identify himself/herself to an authorized poll worker, and then sign a “sign-in sheet.” For such polling places, the present invention may include a step, wherein the sign-in sheets are scanned using an optical scanner 105, and wherein the images of the sign-in sheets are subsequently stored in poll database 16. Image-processing software can then be used to count the number of participants listed on the sign-in sheets. Additionally, justificative data may include provenance data for the sign-in sheets. For each polling place, multiple records could thus be created to contain various types of justificative data for the polling place.

Within this embodiment, the result 107 of the election is determined by tallying the interpreted votes in the poll database 16. For example, a two-person election could be decided by counting the affirmative votes for both candidates and deeming the candidate with the most affirmative votes to be the winner. For multiple-candidate elections, known tallying schemes such as instant runoff (Farrell, 2001) can also be used. The tally results, as well as any intermediate results computed during the tally process, can be stored as derived data records in poll database 16.

Poll data stored in poll database 16, including input data, preference data, derived data, and justificative data, can be disseminated to interested parties in several ways, including via data transfer over a communication network in a standard format such as XML. Other embodiments, however, may disseminate the poll data on physical media such as a CD-ROM or DVD.

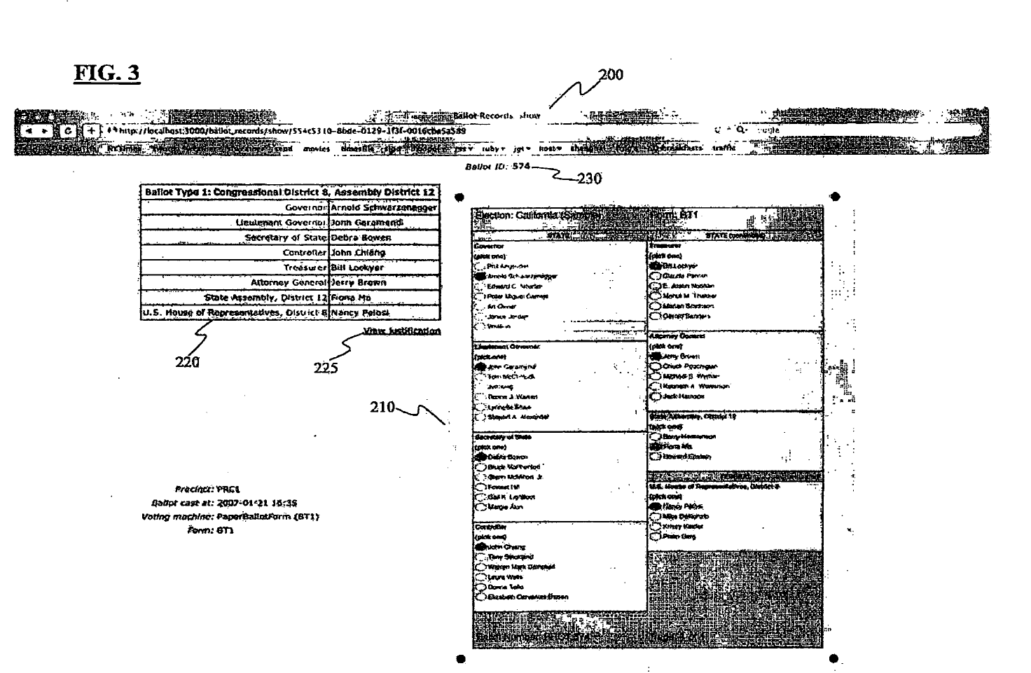

Notwithstanding the particular medium or mechanism by which input data is collected or disseminated, access and manipulation of the poll data by any of a plurality of election analysis systems 109, 110 is contemplated as part of the present invention, wherein such output is summarized in an electronic report. For example, a user interface may be used that allows interactive inspection of the contents, including a display of scanned images of the paper forms 101. A standard database query language can also be used, as well as software that uses an application programming interface (API) 108. The API may, for example, specify a particular subroutine from a library. Such subroutines may include subroutines for selecting, sorting, filtering, summarizing, or retrieving the poll data in the poll database 16, for use by other election analysis systems 109, 110. In a preferred embodiment, poll database 16 is accessed and processed via a Web page 200 as illustrated in FIG. 3. As shown, Web page 200 includes a scanned image of a voter's filled out ballot form 210, an electronic report summarizing the voter's interpreted preference data 220, a button for obtaining further justificative data 225, and a ballot identification number 230.

In some embodiments, the poll database may include information that is only accessible to authorized parties. For example, voter addresses and signatures included in the participation data 130 may be considered sensitive data. Parties that do not have authorization will not be able to view the sensitive data, or may receive data records in which the sensitive data has been obscured. In such embodiments, the data dissemination and analysis systems 109, 110 will require users to provide credentialing information, such as a password and/or challenge-response dialog, in order to authorize access to portions of the data.

It should also be appreciated that interested parties can use information available in poll database 16 to conduct an audit in various ways. An interested party may, for example, manually tally the votes recorded in poll database 16 on his/her own, and compare his/her results to those computed by the official election holder. Meanwhile, another interested party may create a custom algorithm for interpreting votes on a scanned paper ballot form, and compare these customized results to those computed by the official election holder. Other methods include: analyzing the voter participation records to ensure that the sum of voters counted at each polling place equals the total number of ballots recorded in the poll database 16; statistically analyzing the distributions of votes in order to identify anomalies; examining the legitimacy of voters recorded as participating; and inspecting provenance data to ensure that proper procedures were followed.

By exploring different means for interpreting, tallying, and analyzing poll data, the result of an election 107 obtains increased credibility. An interested party may, for example, publish his/her findings of a polling error, wherein such findings may be readily confirmed by other interested parties. Similarly, an election holder may conduct a self-audit as a way to validate his/her own results before releasing them to the public, or as a way to validate these results after their release. The present invention thus provides a method and system for providing a polling process with increased transparency. Consequentially, any discrepancies or irregularities revealed through such audits can be used as reference material for challenges and/or confirmations to the election process or results.

In another embodiment, the present invention gathers poll data from polls utilizing direct-recording electronic (DRE) voting machines. In FIG. 3, a flowchart describing such an embodiment is provided. Within such embodiment, voters who use a DRE voting machine 112 express a preference on a ballot by touching a touch-sensitive screen 115 to select one of several displayed check boxes 114. Selected checkboxes 113 are indicated graphically so that the voter can verify his/her selection visually. For such embodiments, vote interpretation is a function of the nature of the particular voter's interaction with the touch-sensitive screen 115. For example, selection of a check box 114 may be determined by the duration and area coverage of a voter's touch. As such, justificative data for this embodiment can include the electronic signals generated by the voter's interaction with the touch-sensitive screen, as well as other information made available by the DRE voting machine.

Justificative data may also include image scans of “paper trail” printouts 117 (also known as Voter Verified Paper Trails (“VVPTs”)) generated by a DRE voting machine, and subsequently scanned with an optical scanner 105. These image scans may then be processed using optical character recognition (OCR) or other technology, in order to produce poll data in a manner similar to that described for paper ballots. This allows interested parties to conduct further types of audits including: tallying the VVPT records, so as to compare the results of such tally against the records or totals created digitally by the DRE voting machines; and correlating actual VVPTs with their corresponding digital copies, to verify agreement.

In another embodiment, the present invention gathers poll data from polls utilizing marksense technology. Within such an embodiment, voters express a preference by marking a choice on a ballot card. For such embodiments, tabulating equipment, which includes a sensor capable of detecting the marks, performs vote interpretation. Justificative data for this embodiment can include information made available by the tabulating equipment.

Justificative data may also include image scans of the ballot cards, scanned with an optical scanner 105. These image scans may then be processed in the same manner as describe above for paper voting forms 101. This allows interested parties to conduct further types of audits including: tallying the image scan records, so as to compare the results of such tally against the records or totals created digitally by the marksense equipment.

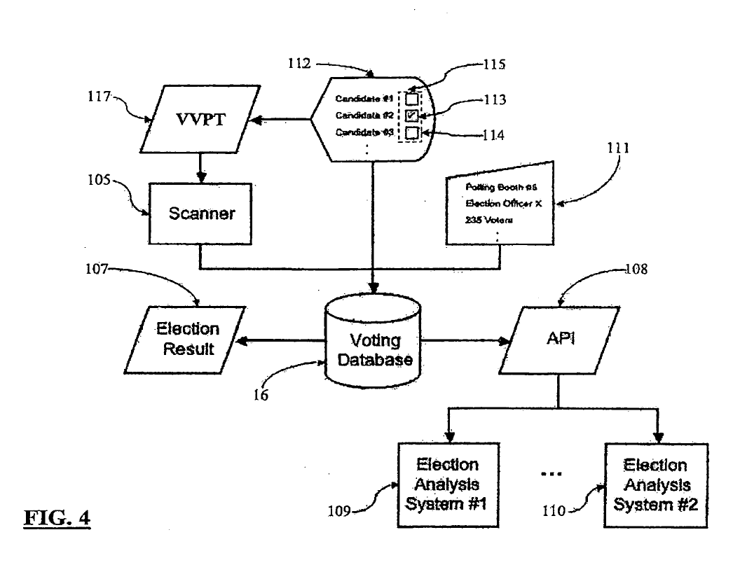

In another embodiment, the present invention gathers poll data from polls conducted over an electronic communications network, such as the Internet. In FIG. 4, a flowchart is provided for such embodiment. As illustrated, ballot forms are presented as online forms 124 on a client computer 119. For many online polls, a voter must first be authenticated by an authentication program. A voter, for example, may be asked to provide credentialing information, such as a password and/or challenge-response dialog 121. After the voter is authenticated, the voter may enter his/her input data onto online form 124 by selecting one of several displayed checkboxes 123. Selected checkboxes are then indicated graphically 122 so that the voter can visually verify his/her selection. When a ballot is cast, the voter is presented with a generated image of the completed form, which can be printed as a printout 125 and retained by the voter.

It should be appreciated that several types of justificative data may be gathered from online polls. Provenance data, for example, may include: time stamps and checksums for each ballot; an image of the completed ballot form; and computer network data such as web client types. Participation data may also be gathered, which may include logs of the credentialing process, as well as computer network data such as IP addresses and web client types. Once gathered, provenance and participation data can then be communicated from the client computer 30 to the auditable polling system 10 via a standard network communication protocol.

In another embodiment, ancillary data may also be collected from voters and stored in poll database 16. Such data can be used for a deeper analysis and better understanding of the preferences and intentions of voters. One form of ancillary data is demographic information. Each voter may, for example, be provided with a ballot that has the voter's demographic information pre-filled. Alternatively, demographic data on ballots may be blank so that voters may fill it in at their discretion. The voter's demographic information may likewise be included in the participation data. Other forms of ancillary data include: responses to ancillary questions that may be included on a ballot form; annotations; and commentary (wherein annotations and commentary can be used to gather from each voter a rationale or explanation for a given vote).

In other embodiments, it should also be appreciated that the election holder and/or interested parties may gauge the overall quality of the poll data, so as to identify ambiguous data and/or to facilitate refinmenet of the database, i.e., correction, modification, or amendment of the poll data, in order to more accurately reflect the voters' intentions or more accurately capture justificative data. Such quality may also be considered in calculating a poll's margin of error. This quality control feature can be implemented using a variety of techniques, either singly or in combination.

In one such technique, each item in the poll database 16 includes a tag indicating its status. The tag indicates possible conditions of ambiguity such as “invalid”, or “unclear”; possible dispositions such as “approved”, “missing” or “provisional”; and so forth. For example, if a voter uses a paper ballot form and the image processing software determines that two ovals are filled-in for an item in which voters are only allowed to select one, the vote may be tagged “invalid”. Or, if the image processing software is unable to make a determination of whether an oval is filled, the vote may be tagged “unclear”. These items may also be manually checked against their justificative data, to see if the voter's intention can be deduced.

In another technique, random sampling of stored images of ballot forms are visually inspected or analyzed by image-processing software and compared with their corresponding records of vote preferences in the poll database 16. Similarly, the signal data generated by a DRE voting machine can be examined to confirm that preference data was captured correctly.

Another technique may involve using statistical tests to identify data that needs verifying. For example, improbable distributions of vote preferences can be detected, including overly high or low rates of error or lack of clarity in the vote interpretation. As another example, demographic data gathered with the input data or participation data can be analyzed for consistency with known demographic information of the corresponding voting precincts. Other examples of where verification might be needed include instances where there is a mismatch between participation count and record count, which may indicate a need to find missing data.

Another technique may involve examining write-in choices, and regularizing them to provide uniform spelling and name order, for more accurate counting. For example, ballots that include write-in choices written in of any variety of forms such as “Johnathan Doe”, “John Doe”, or “Doe, John”, may be regularized to refer uniformly to “Doe, Johnathan”.

In a preferred embodiment, any changes or amendments to the poll data that are made are logged. These logs are then stored in the poll database 16 as further justificative data. For each change to a voting datum, the log might include the voting datum prior to the change, why the change was made, when the change was made, who made the change, and who authorized or approved the change.

In other embodiments, access to poll database 16, and election analysis systems 109, 110, provide the ability to sort or filter the poll data in various ways, used singly or in combination. Examples of such sorting or filtering include: selecting records based on provenance data such as geographic region; selecting records based on status information such as validity; and selecting to accept or ignore certain amendments. After sorting or filtering the poll data, further processing steps may be performed, such as calculating derived data based on the filtered data or performing statistical analysis on the filtered data.

It should be noted that the present invention may also be designed so as to allow voters to identify their own ballots in poll database 16. Such a feature provides voters the ability to verify that their particular ballots were interpreted and tallied correctly. Ballots, for example, may include an identifying serial number. This serial number may then be included in the justificative data for that vote, and be visible on the scanned image of the ballot form.

Alternatively, a voter may personalize his/her paper or electronic ballot form. For example, a voter may provide a series of letters or numbers of their own choosing, which will be included in poll database 16 in the same manner as the serial numbers discussed above. A voter may also stamp the form with either a physical or electronic seal. The voter's placement of the seal and/or the strength of the seal imprint provide personally recognizable information that is visible on the stored images of the ballot forms. The voter may also make arbitrary graphical marks on the ballot forms, which are visible in the stored image of the ballot form. And finally, a voter may waive anonymity and simply sign his/her ballot, such that his/her signature is visible in the stored image of the ballot form.

### EXAMPLES

The present invention is described by reference to the following examples, which are offered by way of illustration and are not intended to limit the invention in any manner. Standard techniques well known in the art or the techniques specifically described below are utilized. Those skilled in the art will recognize, or be able to ascertain, using no more than routine experimentation, many equivalents to the specific embodiments of the invention described specifically herein. Such equivalents are intended to be encompassed within the scope of the following claims.

### Example 1

### A Poll Using Paper Ballots

In such a poll, the voters express their preferences by filling out paper ballots. The cast paper ballots are scanned and the images processed to determine the votes, which are entered into a database. The results are determined by performing tally operations on the data in the database. The complete database, including the ballot images and their corresponding interpreted votes, is then made available to the public.

In this application, the present invention performs the role otherwise performed in current practice by manually examining and tallying the votes/ballots. The benefits provided by the present invention are those of transparency and repeatability: The examination of the ballots is automated; the interpretation of each ballot is known and can be verified by anyone; the counting can be performed with complete accuracy; no manual recounts are needed--in case of dispute, the completeness and accuracy of the data in the database can be verified or amended, but the act of tallying is a trivial computer operation and does not require physically handling all the ballots again.

### Example 2

### A poll Using DREs with VVPTs

In such a poll, voters express their preferences using direct-recording machines that gather the data digitally and also print a paper trail record for each ballot. By scanning and performing OCR on (all) the paper trail records, an auxiliary digital dataset is created that reflects the paper trail version of the balloting. This dataset can then be compared against the digital ballot data gathered directly by the DREs. Any discrepancies in the number of ballots or in the vote tallies would indicate possible error. The original DRE data and the paper trail dataset, including the images of the records, are then disseminated so that any interested party can perform the analysis themselves.

In this application, the present invention performs the role otherwise intended in current practice to be accomplished by manually hand-verifying a small percentage of paper trail records. The benefits provided by the present invention include: It allows all the paper trail records to be verified rather than only a small percentage; the public audit allows the checking to be repeated and confirmed by interested parties.

### Example 3

A group or an association conducting a public audit vote by email/internet. (Specific examples could include: School class or club elections; Law firm partners voting on new partner candidates; Graduate students voting on how to spend a particular fund; A family voting on where to go on vacation.)

In such a poll, voters cast their ballots via a web page or by responding to an automated email message. Each virtual ballot includes a predefined (random) serial number, to which each voter can append an arbitrary alphanumeric string of their own choosing—this lets each voter be certain that they can subsequently recognize their own ballot.

Once the poll closes, a poll-results web page shows a table listing all the ballots, including their serial numbers; this allows each voter to find their own ballot and be sure it was included and that it has the correct data. The web page separately lists the names of all the voters who participated (not correlated with the ballots), so that anyone can check that only authorized people voted and that the number of ballots matches the number of voters. The data from the web page can be downloaded in a standard file format, so that anybody can verify the tallies or otherwise analyze the data.

In this application, the present invention performs the role of existing internet-based polling systems, but provides the added benefits that each participant can be assured that his/her ballot was included properly, and that any interested party can verify that there are no discrepancies in the vote counting.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A method for auditing a poll comprising:
collecting poll data;
generating a poll database comprising said poll data; and
publishing said poll data in said poll database, wherein said poll data is accessible to at least one interested party.

2. The method of claim 1, wherein said poll data comprises input data entered by a poll participant onto a ballot form.

3. The method of claim 2, wherein said ballot form is a tangible ballot form.

4. The method of claim 2, wherein said ballot form is submitted via a direct-recording electronic voting machine.

5. The method of claim 2, wherein said ballot form is submitted via a marksense voting machine.

6. The method of claim 2, wherein said ballot form is submitted via a device comprising a display screen.

7. The method of claim 2, wherein said ballot form is submitted via a device comprising audio input and output technology.

8. The method of claim 2, wherein said ballot form is submitted via an electronic communication network.

9. The method of claim 2, wherein said input data comprises indications of choices on the ballot form.

10. The method of claim 2, wherein said input data comprises free-response data.

11. The method of claim 2, wherein said input data comprises ancillary data.

12. The method of claim 11, wherein said ancillary data comprises demographic data.

13. The method of claim 11, wherein said ancillary data comprises responses to questions on the ballot.

14. The method of claim 11, wherein said ancillary data comprises explanations of preferences or opinions.

15. The method of claim 11, wherein said ancillary data comprises annotation of the ballot form.

16. The method of claim 2, wherein said ballot form comprises an identifier.

17. The method of claim 16, wherein said identifier comprises a serial number.

18. The method of claim 16, wherein said identifier comprises an arbitrary alphanumeric string.

19. The method of claim 16, wherein said identifier comprises a graphical mark.

20. The method of claim 16, wherein said identifier comprises portions provided by said poll participant.

21. The method of claim 16, wherein said identifier comprises the identity of said poll participant.

22. The method of claim 1, wherein said poll data comprises preference data.

23. The method of claim 22, wherein said preference data comprises input data.

24. The method of claim 22, wherein said preference data is acquired by interpreting input data in said poll data.

25. The method of claim 1, wherein said poll data comprises justificative data.

26. The method of claim 25, wherein said justificative data comprises participation data.

27. The method of claim 25, wherein said justificative data comprises records of ballot forms.

28. The method of claim 25, wherein said justificative data comprises explanations of vote interpretation.

29. The method of claim 25, wherein said justificative data comprises provenance data.

30. The method of claim 25, wherein said justificative data comprises credentialing data.

31. The method of claim 25, wherein said justificative data comprises records of decisions relating to the polling process.

32. The method of claim 25, wherein said justificative data comprises records of procedures followed relating to the polling process.

33. The method of claim 25, wherein said justificative data comprises records of amendments to the poll data.

34. The method of claim 25, wherein said justificative data comprises records of data processing steps performed on the poll data.

35. The method of claim 25, wherein said justificative data comprises digital images of tangible documents.

36. The method of claim 35, wherein said tangible documents comprise tangible ballot forms.

37. The method of claim 35, wherein said tangible documents comprise paper trail records produced by direct recording electronic voting machines.

38. The method of claim 35, wherein said tangible documents comprise paper participation records.

39. The method of claim 35, wherein said tangible documents comprise paper authorization or approval documents.

40. The method of claim 25, wherein said justificative data comprises recordings of audio interactions.

41. The method of claim 25, wherein said justificative data comprises digital records.

42. The method of claim 41, wherein said digital records comprise justificative data provided by direct recording electronic voting machines.

43. The method of claim 41, wherein said digital records comprise justificative data provided by marksense voting machines.

44. The method of claim 41, wherein said digital records comprise logs of credentialing processes.

45. The method of claim 41, wherein said digital records comprise checksum or other validation data.

46. The method of claim 1, wherein said poll data comprises derived data.

47. The method of claim 46, wherein said derived data comprises a tally of preference data.

48. The method of claim 47, wherein said tally includes a margin of error.

49. The method of claim 46, wherein said derived data comprises statistical analysis of poll data.

50. The method of claim 1, wherein said database comprises data status information.

51. The method of claim 50, wherein said status information includes indications of validity or invalidity.

52. The method of claim 50, wherein said status information includes indications of certainty or uncertainty.

53. The method of claim 50, wherein said status information includes indications of data disposition.

54. The method of claim 1, further comprising data processing steps.

55. The method of claim 54, further comprising the step of interpreting images.

56. The method of claim 55, wherein said images are images of ballot forms.

57. The method of claim 55, wherein said images are images of paper trail records.

58. The method of claim 55, wherein said images are images participation forms.

59. The method of claim 55, wherein said step of interpreting images comprises optical character recognition.

60. The method of claim 55, wherein said step of interpreting images comprises analyzing graphical marks.

61. The method of claim 54, further comprising the step of identifying ambiguous input data.

62. The method of claim 54, further comprising the step of amending the poll data.

63. The method of claim 62, further comprising the step of correcting errors.

64. The method of claim 62, further comprising the step of adding data.

65. The method of claim 62, further comprising the step of striking data.

66. The method of claim 62, further comprising the step of assigning status information.

67. The method of claim 62, wherein said amending step is performed only by properly authenticated ones of said at least one interested party.

68. The method of claim 54, further comprising the step of calculating derived data.

69. The method of claim 1, wherein said poll data may be sorted or filtered.

70. The method of claim 69, wherein said poll data is sorted or filtered according to at least one of a plurality of elements associated with said poll data.

71. The method of claim 69, wherein said poll data is sorted or filtered according to amendment history of said poll data.

72. The method of claim 69, wherein said poll data is sorted or filtered according to the result of processing steps.

73. The method of claim 69, wherein further derived data is calculated based on said sorted or filtered poll data.

74. The method of claim 69, wherein further processing steps are performed based on said sorted or filtered poll data.

75. The method of claim 1, wherein said poll data is published in tangible form.

76. The method of claim 1, wherein said poll data is published electronically.

77. The method of claim 76, wherein said poll data is disseminated via an electronic communication network.

78. The method of claim 76, wherein said poll data is disseminated via a physical medium.

79. The method of claim 76, wherein access to said poll data is via an application programming interface.

80. The method of claim 76, wherein access to said poll data is via a user interface.

81. The method of claim 76, wherein access to said poll data is via a database query language.

82. The method of claim 76, wherein portions of the poll data are accessible only to properly authenticated ones of said at least one interested party.

83. A computer readable medium comprising said published poll data produced by the method of claim 1.

84. A computer readable medium comprising said published poll data produced by the method of claim 54.

85. A computer readable medium comprising said published poll data produced by the method of claim 69.

86. A computer readable medium comprising said published poll data produced by the method of claim 76.

87. A system for auditing a poll comprising:
a server connected to a computer network and a data management application executing in association with said server to provide the functions of:
obtaining poll data;
creating a poll database comprising said poll data; and
publishing said poll data in said database, wherein said poll data is accessible to at least one interested party.

88. The system of claim 87, wherein said poll data comprises input data entered by a poll participant onto a ballot form.

89. The system of claim 88, wherein said ballot form is a tangible ballot form.

90. The system of claim 88, wherein said ballot form is submitted via a direct-recording electronic voting machine.

91. The system of claim 88, wherein said ballot form is submitted via a marksense voting machine.

92. The system of claim 88, wherein said ballot form is submitted via a device comprising a display screen.

93. The system of claim 88, wherein said ballot form is submitted via a device comprising audio input and output technology.

94. The system of claim 88, wherein said ballot form is submitted via an electronic communication network.

95. The system of claim 88, wherein said input data comprises indications of choices on the ballot form.

96. The system of claim 88, wherein said input data comprises free-response data.

97. The system of claim 88, wherein said input data comprises ancillary data.

98. The system of claim 97, wherein said ancillary data comprises demographic data.

99. The system of claim 97, wherein said ancillary data comprises responses to questions on the ballot.

100. The system of claim 97, wherein said ancillary data comprises explanations of preferences or opinions.

101. The system of claim 97, wherein said ancillary data comprises annotation of the ballot form.

102. The system of claim 88, wherein said ballot form comprises an identifier.

103. The system of claim 102, wherein said identifier comprises a serial number.

104. The system of claim 102, wherein said identifier comprises an arbitrary alphanumeric string.

105. The system of claim 102, wherein said identifier comprises a graphical mark.

106. The system of claim 102, wherein said identifier comprises portions provided by said poll participant.

107. The system of claim 102, wherein said identifier comprises the identity of said poll participant.

108. The system of claim 87, wherein said poll data comprises preference data.

109. The system of claim 108, wherein said preference data comprises input data.

110. The system of claim 108, wherein said preference data is acquired by interpreting input data in said poll data.

111. The system of claim 87, wherein said poll data comprises justificative data.

112. The system of claim 111, wherein said justificative data comprises participation data.

113. The system of claim 111, wherein said justificative data comprises records of ballot forms.

114. The system of claim 111, wherein said justificative data comprises explanations of vote interpretation.

115. The system of claim 111, wherein said justificative data comprises provenance data.

116. The system of claim 111, wherein said justificative data comprises credentialing data.

117. The system of claim 111, wherein said justificative data comprises records of decisions relating to the polling process.

118. The system of claim 111, wherein said justificative data comprises records of procedures followed relating to the polling process.

119. The system of claim 111, wherein said justificative data comprises records of amendments to the poll data.

120. The system of claim 111, wherein said justificative data comprises records of data processing steps performed on the poll data.

121. The system of claim 111, wherein said justificative data comprises digital images of tangible documents.

122. The system of claim 121, wherein said tangible documents comprise tangible ballot forms.

123. The system of claim 121, wherein said tangible documents comprise paper trail records produced by direct recording electronic voting machines.

124. The system of claim 121, wherein said tangible documents comprise paper participation records.

125. The system of claim 121, wherein said tangible documents comprise paper authorization or approval documents.

126. The system of claim 111, wherein said justificative data comprises recordings of audio interactions.

127. The system of claim 111, wherein said justificative data comprises digital records.

128. The system of claim 127, wherein said digital records comprise justificative data provided by direct recording electronic voting machines.

129. The system of claim 127, wherein said digital records comprise justificative data provided by marksense voting machines.

130. The system of claim 127, wherein said digital records comprise logs of credentialing processes.

131. The system of claim 127, wherein said digital records comprise checksum or other validation data.

132. The system of claim 87, wherein said poll data comprises derived data.

133. The system of claim 132, wherein said derived data comprises a tally of preference data.

134. The system of claim 133, wherein said tally includes a margin of error.

135. The system of claim 132, wherein said derived data comprises statistical analysis of poll data.

136. The system of claim 87, wherein said database comprises data status information.

137. The system of claim 136, wherein said status information includes indications of validity or invalidity.

138. The system of claim 136, wherein said status information includes indications of certainty or uncertainty.

139. The system of claim 136, wherein said status information includes indications of data disposition.

140. The system of claim 87, further comprising data processing steps.

141. The system of claim 140, further comprising the step of interpreting images.

142. The system of claim 141, wherein said images are images of ballot forms.

143. The system of claim 141, wherein said images are images of paper trail records.

144. The system of claim 141, wherein said images are images participation forms.

145. The system of claim 141, wherein said step of interpreting images comprises optical character recognition.

146. The system of claim 141, wherein said step of interpreting images comprises analyzing graphical marks.

147. The system of claim 140, further comprising the step of identifying ambiguous input data.

148. The system of claim 140, further comprising the step of amending the poll data.

149. The system of claim 148, further comprising the step of correcting errors.

150. The system of claim 148, further comprising the step of adding data.

151. The system of claim 148, further comprising the step of striking data.

152. The system of claim 148, further comprising the step of assigning status information.

153. The system of claim 148, wherein said amending step is performed only by properly authenticated ones of said at least one interested party.

154. The system of claim 140, further comprising the step of calculating derived data.

155. The method of claim 87, wherein said poll data may be sorted or filtered.

156. The method of claim 155, wherein said poll data is sorted or filtered according to at least one of a plurality of elements associated with said poll data.

157. The method of claim 155, wherein said poll data is sorted or filtered according to amendment history of said poll data.

158. The method of claim 155, wherein said poll data is sorted or filtered according to the result of processing steps.

159. The method of claim 155, wherein further derived data is calculated based on said sorted or filtered poll data.

160. The method of claim 155, wherein further processing steps are performed based on said sorted or filtered poll data.

161. The system of claim 87, wherein said poll data is published in tangible form.

162. The system of claim 87, wherein said poll data is published electronically.

163. The system of claim 162, wherein said poll data is disseminated via an electronic communication network.

164. The system of claim 162, wherein said poll data is disseminated via a physical medium.

165. The system of claim 162, wherein access to said poll data is via an application programming interface.

166. The system of claim 162, wherein access to said data is via a user interface.

167. The system of claim 162, wherein access to said data is via a database query language.

168. The system of claim 162, wherein portions of the data are accessible only to properly authenticated ones of said at least one interested party.

169. A computer readable medium comprising said published poll data produced by the system of claim 87.

170. A computer readable medium comprising said published poll data produced by the system of claim 140.

171. A computer readable medium comprising said published poll data produced by the system of claim 155.

172. A computer readable medium comprising said published poll data produced by the system of claim 162.
